(19) United States
(12) Patent Application Publication
(10) Pub. No.: US 2013/0337174 A1
(43) Pub. Date: Dec. 19, 2013

(54) VAPORIZATION SOURCE, VAPORIZATION CHAMBER, COATING METHOD AND NOZZLE PLATE

(71) Applicants: Christof Goebert, Dessau-Rosslau (DE); Frank Ulmer, Leipzig (DE); Hendrik Zachmann, Leipzig (DE); Jens Roessler, Borsdorf (DE); Heiko Schuler, Simmozheim (DE); Frank Huber, Tuebingen (DE); Oliver Leifeld, Stuttgart (DE)

(72) Inventors: Christof Goebert, Dessau-Rosslau (DE); Frank Ulmer, Leipzig (DE); Hendrik Zachmann, Leipzig (DE); Jens Roessler, Borsdorf (DE); Heiko Schuler, Simmozheim (DE); Frank Huber, Tuebingen (DE); Oliver Leifeld, Stuttgart (DE)

(73) Assignee: SOLARION AG - PHOTOVOLTAIK, Leipzig (DE)

(21) Appl. No.: 13/897,339

(22) Filed: May 17, 2013

Related U.S. Application Data
(63) Continuation of application No. PCT/EP2011/006383, filed on Dec. 16, 2011.

(30) Foreign Application Priority Data
Dec. 21, 2010 (DE) DE102010055285.2

(51) Int. Cl. B05B 1/00

(52) U.S. Cl. CPC B05B 1/005
USPC 427/255.395; 118/726

(57) ABSTRACT

The invention relates to vaporization source, an evaporation chamber, a coating method and a nozzle plate. The vaporization source according to the invention makes it possible to generate a high, stable melt flow rate having improved layer thickness homogeneity under vacuum conditions in a selenium atmosphere. The direction of the molecular flow of the vaporization source can be adjusted with respect to the substrate support located above the vaporization source.

### RELATED APPLICATIONS

This application is a continuation of PCT/EP2011/006383, filed on Dec. 16, 2011, claiming priority from German Patent Application DE 10 2010 055 285.2, filed on Dec. 21, 2010, both of which are incorporated in their entirety by this reference.

### FIELD OF THE INVENTION

The invention relates to a linear evaporation source according to the preamble of claim 1, an evaporation chamber according to the preamble of claim 7, a coating method according to the preamble of claim 10 and a nozzle plate according to the preamble of claim 11.

### BACKGROUND OF THE INVENTION

Deposition techniques for producing thin layers under vacuum are generally known. Requirements for an industrial use of molecular beam epitaxy (MBE) and other vapor deposition methods are increasing continuously, in particular for a flexible substrate support with increasing substrate width with a goal of homogeneous layer deposition, a deposition rate that is as high as possible and their operating environment.

For example in photovoltaics, more and more vendors of thin layer solar cells enter the marketplace. Thin layer solar cells which are in particular based on a chalcopyrite absorber layer are mostly produced on rigid carrier substrates like glass but they also have the advantage that they can also be produced on light, flexible carrier substrates, for example in a roll to roll (R2R) process. For flexible substrates, in particular steel, titanium, aluminum, copper, and polyimide (PI) foils can be used. The substrate is subsequently coated with a metal electrode, for instance a thin molybdenum film. Subsequently, the chalcopyrite is applied as an absorber layer, typically in a vacuum based vapor deposition process. In particular, CuInSe₂, Cu(In,Ga)Se₂, and Cu(In,Ga)(Se₂S)₂ are being used as chalcopyrites, subsequently designated CIS. It has proven particularly advantageous to vaporize the elements in a sulfur, telluride and/or selenium atmosphere. Subsequently, a semiconductor layer made from CdS or similar and a second electrode layer (on the front side) which is made from a thin transparent conductive layer (TCO-transparent conductive oxide) thus ITO (indium tin oxide) or ZNO is applied. Additionally, an efficiency of CIS solar cells can be improved through controlled supply of alkalines, preferably lithium, potassium and sodium and/or their compounds with oxygen, sulfur or halogenides which can be implemented among other methods through vaporization.

In order to further minimize the cost of the production process, in particular of the CIS absorber, the substrate width will increase further in coming years and the deposition rates will be increased. A development away from a punctiform evaporation sources towards linear evaporation sources is therefore unavoidable to implement high rate deposition that is efficient with respect to material yield.

A line shaped evaporation source subsequently designated as linear evaporation source is a concatenation of a plurality, this means of at least two punctiform evaporation sources subsequently designated as punctiform evaporators which have a joint evaporation material container or an evaporator apparatus whose vapor exit opening in longitudinal direction of the linear evaporation source is configured slot shaped, this means that a longitudinal extension of the vapor outlet opening is substantially larger than its transversal extension.

One of the greatest challenges when developing linear evaporation sources is providing the best possible transversal homogeneity of the layers vapor deposited on the substrate. The transversal homogeneity of the substrate is defined as homogeneity of the vapor deposited layer orthogonal to a transport direction. An option to optimize transversal homogeneity is adapting the molecule flow density along the longitudinal direction of the linear evaporation source which is arranged with its longitudinal direction parallel to the transversal direction of the substrate.

In this approach, the surface of plural vapor outlet openings arranged in longitudinal direction of the linear evaporation source is increased from the inside out and/or the distance of plural vapor outlet openings arranged in longitudinal direction of the linear evaporation source is made smaller from the inside out so that a gradient of molecule flow densities of the molecule beams of the evaporation material that originates from the vapor outlet openings is provided which increases from the inside out which molecule beams superimpose on the substrate surface to form a homogeneous film. Another option to influence transversal homogeneity is modulating the molecule beam shape.

Subsequently, a differentiation is made between vapor outlet opening and vapor pass through openings, wherein vapor outlet openings are openings where the vapor exits from the evaporation source. In openings like the ones of throttle apertures, the material does not leave the evaporation source. Therefore, the openings are designated as vapor pass through openings.

EP 0402 842 B1 describes an evaporation apparatus in which a substance is evaporated from at least one tube in order to use the vapor as an excited or ionized medium in a vapor ion laser device, wherein the diameter of the vapor outlet openings proximal to the axial opposed ends of the tube is greater than in the center or the number of vapor outlet openings increases in outward direction.

DE 44 22 697 C1 illustrates a linear evaporation source which includes an upward open evaporation material container with a material receiving indentation and a heatable reflector element enveloping the evaporation material container, wherein the linear outlet profile of the reflector element includes a plurality of individual openings arranged behind one another and whose outlet cross-section increases towards the end portions of the reflector tube and/or whose distance decreases towards the end portions of the reflector tube. Furthermore, a heat shield is arranged about the reflector tube which is configured in a portion of the one vapor outlet slot so that an evaporation flow is not influenced.

EP 1 927 674 A2 describes a linear evaporation source including an evaporation chamber and a beam unit arranged there above (cabinet part) which are connected with one another through a nozzle or throttle aperture, wherein the nozzle unit includes plural nozzles. The nozzle aperture includes vapor pass through openings whose surfaces continuously increase from an aperture center to an aperture edge and/or wherein a distance of the vapor pass through openings becomes smaller from the aperture center to an aperture edge. The molecular beams of the vapor pass through openings are separated from one another through partition plates in the nozzle unit.

WO 2008/004792 A1 describes a linear evaporation source including a crucible and a nozzle unit including plural vapor outlet openings. The vapor outlet openings are introduced into the nozzle unit as tubular nozzles whose longitudinal axes are arranged at an angle relative to a vertical axis of the crucible. The tubular nozzles are arranged mirror symmetrical with respect to the longitudinal and transversal elevation planes of the crucible divided into two or four groups along the longitudinal orientation of the crucible, wherein the nozzles within a group can have different inclinations. Furthermore the surface of the outlet openings of the nozzles can be varied through the formation of a plateau of the nozzle unit.

The described concepts are typically very complicated and/or still cannot provide the necessary homogeneity.

### BRIEF SUMMARY OF THE INVENTION

Thus, it is an object of the invention to provide a linear evaporation source which overcomes the current disadvantages of the known evaporation sources. The linear evaporation source according to the invention shall provide a mass flow rate that is as high and stable as possible with improved layer thickness homogeneity, in particular under vacuum conditions in a sulfur, telluride, and/or selenium atmosphere. Advantageously, the molecular flow direction of the evaporation source shall be adjustable relative to the substrate support or holder arranged above the evaporation source. Furthermore, an improved method with preferably continuous support of flexible substrates for producing vacuum vapor deposition layers, preferably chalcopyrite layers, in particular CIS is of interest. Preferably, the linear evaporation source shall be flexibly adaptable to the substrate width, this means scalable.

This object is achieved through a linear evaporation source, in particular for vacuum deposition arrangements including at least one evaporation material container including an indentation for receiving the evaporation material, at least one heat source, and at least two nozzles arranged offset in longitudinal direction of the linear evaporation source, wherein the nozzles respectively include at least one vapor outlet opening, wherein the evaporation material container includes a container axis, wherein the at least one vapor outlet opening includes at least two wall sections which preferably extend substantially vertical to the longitudinal direction and which are oriented not parallel or orientable not parallel to one another, wherein the evaporation material container is separable into at least two evaporation material container modules which are not separated from one another in a joined condition of the evaporation material container so that an identical vapor equilibrium pressure is established in or over each evaporation material container module through evaporating evaporation material in the respective evaporation material container module

This object is also achieved by an evaporation chamber, comprising: at least one evaporation source and at least one substrate holder or substrate support for flat substrates, band substrates or similar, wherein the evaporation source is a linear evaporation source according to one of the preceding claims, wherein it is preferably provided that the container axis of the linear evaporation source is arranged or arrangeable relative to the gravitation orientation inclined by 0° to 40°, preferably 10° to 25°, particularly preferably 15°.

This object is also achieved by a method for coating substrates wherein the process environment preferably includes sulfur, telluride, and/or selenium, and in particular at least one chalcopyrite layer is generated. Advantageous embodiments are provided in the dependent claims.

The linear evaporation source according to the invention, in particular for vacuum deposition arrangements, includes an evaporation material container with an indentation for receiving the evaporation material, in particular copper, indium, gallium, but also gold, aluminum, silver, sodium, potassium, and lithium and their compounds with oxygen, sulfur or halogenides and at least one heat source, wherein the evaporation material container includes a container axis and furthermore at least one nozzle extending in longitudinal direction and/or at least two nozzles arranged offset in longitudinal direction of the linear evaporation source, wherein the nozzles respectively include at least one vapor outlet opening, and is characterized in that at least one vapor outlet opening includes at least two wall sections which preferably extend essentially perpendicular to the longitudinal extension and which are oriented not parallel and/or orientable not parallel to one another. This solution according to the invention facilitates particularly effective beam forming through which optimum layer homogeneity is adjustable.

Thus, either at least one nozzle which extends in linear direction of the linear evaporation source or at least two nozzles that are offset in longitudinal direction of the linear evaporation source can be provided. Alternatively, the elements are also combinable with one another, thus for example a nozzle which extends in longitudinal direction of the linear evaporation source, for example having a rectangular cross-section with a nozzle that is arranged offset which does not have a particular longitudinal extension and which has for example a square or circular cross-section. Thus in this case, the rectangular nozzle simultaneously forms one of the nozzles that is arranged with an offset.

It can be advantageously provided that the vapor outlet opening is configured preferably conical with respect to the two wall sections, in particular configured asymmetrically conically expanded, which facilitates influencing the beam profile in a more favorable manner. Preferably, this is a conically expanded configuration with reference to the vapor beam direction.

It is particularly advantageous when the vapor outlet opening includes a longitudinal axis which is arranged and/or arrangeable tilted relative to the container axis, wherein the tilt is preferably 1° to 90°, preferably 10° to 60°, particularly preferably 10° to 45°, in particular 20° to 30°. Then a simultaneous vapor deposition of a particular substrate portion of two or more linear evaporators with different evaporation materials can be adjusted quite well for rigid surface substrates. The tilting in the described portion is particular well suited for coating flexible band substrates on a curved substrate support. An inline and also a batch processing can be provided for rigid and also for flexible substrates.

“Container axis” in this context means the extension between the container base and container cover in which the vapor outlet opening is arranged, wherein the axis is a geometric axis with reference to the container body. The tilt can be provided stationary or adjustable in a controlled manner, for example continuously or discretely adjustable.

“Longitudinal” axis of the nozzle opening means in this context the geometric axis of the nozzle opening, wherein also the preferred direction of the exiting vapor is determined.

It can be advantageously provided that the nozzle openings of the nozzles of the evaporator include longitudinal axes that have different orientations relative to the container axis. Particularly advantageously, the nozzles are arranged in at least one nozzle element, preferably a nozzle plate. Thus, the evaporator is configured in a particularly simple manner. It can be then provided in particular that the nozzle element is disengageably connected with the evaporation material container. “Connected” in this context means directly and also indirectly connected, thus with additional elements connected there between. Then, the evaporator can be quickly adapted to different requirements because the nozzle elements are easily replaceable. Thus, beam forming is simply adjustable for fixated longitudinal axes of the vapor outlet openings through rotating the nozzle element. The disengageable connection can be implemented for example through a clip shaped attachment or similar.

Particularly advantageously, a throttle element is arranged between the nozzle and the indentation, wherein the nozzle element includes at least one throttle opening which is arranged in viewing direction between the nozzle and the indentation. “Viewing direction” in this context means the direction which is defined by geometric beams between each point of the indentation and the nozzle. Thus, the direction is specified which is defined by looking through the nozzle into the indentation. This throttle element facilitates a controlled adjustment of the material vapor amount for each nozzle. Thus, it can be provided that a single throttle opening is associated with each nozzle. Alternatively it is also feasible to associate one or plural throttle openings with each nozzle, wherein the throttle openings preferably include an identical cross-section.

Thus, preferably the overall cross-section area of the throttle openings of the respective nozzle of at least one nozzle arranged further outside with respect to the longitudinal extension can be equal or greater than for at least one nozzle arranged further inside. Preferably this only relates to the throttle openings on the very outside which have another cross-section. The layer homogeneity can be influenced positively in particular through a throttle cross-section surface that is enlarged on the outside, because material volume losses due to adjacent nozzles lacking further outside can thus be compensated.

It is furthermore very advantageous when an aperture element is arranged as a splash guard in viewing direction between the indentation and the throttle opening and/or in viewing direction between the throttle opening and the nozzle, wherein the aperture element covers in particular the overall cross-sectional surface of the throttle openings in viewing direction. This aperture element effectively prevents evaporation material in the form of splashes from exiting. For this configuration, independent patent protection is claimed, this means an evaporation source with an aperture element of this type shall also be protected without the feature of a particular configuration of the nozzle opening and its particular orientation with respect to the container axis.

Advantageously, the nozzle can include at least one heat reflector which includes at least one piece of sheet metal made from a temperature resistant material, for example a material from the group including metals of the fourth to tenth subgroups of the period system of elements and/or their alloys, preferably tungsten, titanium, molybdenum and tantalum, thus preferably high melting metals over 1200° C. and which is advantageously arranged adjacent to or about the vapor outlet opening. This heat reflector is used for minimizing the temperature gradient between the evaporation material container and the nozzle surface.

Additionally, the evaporation material container shall be divisible in a modular manner for lengths greater than 20 cm, this means divisible into plural small evaporation material containers. The ratio of a longitudinal extension to a transversal extension L_{long}/Lₜᵣₐₙₛ of an evaporation material container module shall be at least 5 and at the most 30 times, preferably 15≦L_{long}/Lₜᵣₐₙₛ<25, in particular 19≦L_{long}/Lₜᵣₐₙₛ≦22. For a linear evaporation source length of up to 10 m, the evaporation material container is divided into two, advantageously three to forty, preferably three to twenty, particularly five to ten smaller evaporation material containers. The particular evaporation material containers can be construed so that a vapor pressure equilibrium between throttle element and melt surface of the evaporation material in each evaporation material container is formed separately or the vapor pressure equilibrium from the evaporation of the evaporation material from all evaporation material containers is formed jointly.

In this context or alternatively, it is particularly preferred when the nozzles and optionally additional nozzles are arranged in a nozzle plate as an aperture block. Particularly advantageously, the nozzle plate is configured solid, in particular made from graphite.

It can also be provided that the nozzle element or the nozzle plate is configured modular with plural nozzle elements or nozzle plate segments. This is advantageous for linear evaporation sources with large longitudinal extensions.

The nozzle plate is used for partial control of the vapor flow with respect to its volume and also with respect to its profile for which the opening cross-sections of the vapor outlet openings are configured differently from one another and can also be configured offset differently in the nozzle plate so that the nozzle plate includes a vapor outlet opening arrangement that is adapted to the respectively desired process geometry. Depending on the number of evaporation material containers per linear evaporation source, an identical number of nozzle plates can be provided. For the desired coating profile, then a sequence and orientation of the particular nozzle plates is important. Alternatively also a nozzle plate for two or more evaporation material containers can be provided.

For this configuration of the nozzle and of the nozzle plate, independent protection is claimed, this means that in this context no particular arrangement of the wall sections has to be provided.

Furthermore, independent patent protection is also claimed for the nozzle plate with its various configurations. Thus, the features of the invention associated with the nozzle plate and the nozzles are combinable at will and it is not mandatory that the nozzle plate includes at least one vapor outlet opening with at least two wall sections which are not oriented and/or orientable parallel to one another.

Furthermore, independent patent protection is claimed for the evaporation chamber according to the invention with at least one evaporation source and at least one substrate holder and/or substrate support for flat substrates, flexible band substrates or similar, which is characterized in that at least one evaporation source is the linear evaporation source according to the invention.

Preferably, a flat section is provided as substrate support and/or substrate holder, in which vapor deposition is performed on the substrate, wherein conventional rigid substrates like glass or also flexible substrates can be used as substrates. A band substrate support that includes a curved section can also be used as a substrate support and the linear evaporation source can be configured so that the substrate material is vapor deposited in this curved section. When using a substrate support, a movement of the substrate is used, this is a dynamic substrate coating as performed for inline processes. When using a substrate support, the substrate is not moved during coating relative to the linear evaporation sources. This is a static coating which is typical in batches processes.

For a planar substrate support, optimum utilization of the coating zone that is independent from the evaporator position is important, whereas only a particular portion that depends from the evaporator position can be coated with a curved substrate support. It is an advantage of a curved substrate support over a planar substrate support that much simpler band substrate handling is facilitated.

Particularly advantageously, the container axis of the linear evaporation source is arranged and/or arrangeable relative to the gravitational direction by 0° to 40°, preferably by 10° to 25°, in particular 15°. Then the linear evaporation source can be arranged in a particularly space saving manner in the evaporator chamber, in particular also when using plural evaporation sources.

When at least two linear evaporation sources are provided, it is useful when at least the two linear evaporation sources are arranged or arrangeable at a slant angle relative to one another with respect to their container axes. Alternatively thereto it can also be provided that at least two linear evaporation sources have the same inclination relative to the gravitation axis.

Furthermore it is very advantageous when at least two linear evaporation sources are provided whose respective longitudinal axes of the vapor outlet opening are arranged differently relative to the respective container axis. In particular when the container axes are oriented perpendicular to the gravitation axis, a continuous evaporator power can be provided for defined beam forming because the surface of the evaporation material in the recess is kept constant until the material is completely used up. So to speak, also an arrangement of the container axes parallel to the gravitation axis is useful.

It has proven particularly advantageous when the described linear evaporation source in the described evaporation chamber has a distance of 0.05 m to 2.0 m, preferably 0.1 m to 1 m, in particular 0.3 m to 0.7 m from the substrate, irrespective whether the coating zone is configured planar or bent. The shortest straight line between substrate and evaporator outlet opening of the evaporator is defined as evaporator substrate distance. When at least two linear evaporation sources are used it has proven additionally advantageous when the linear evaporation sources have a distance of 0.01 m to 3.0 m, preferably 0.1 m to 2 m, in particular 0.15 m to 1 m from one another. An evaporator distance in this context is the shortest straight line distance of the vapor outlet openings oriented towards one another of the two linear evaporation sources.

It is furthermore advantageous when at least one punctiform or line shaped ion beam source or another plasma source is arranged in the evaporator chamber, which ion beam source or other plasma source can also be heated whose ion beams or whose plasma can interact more or less with the molecular beams exiting from the at least one linear evaporation source of the evaporation material, in particular copper, indium, gallium, but also gold, aluminum, silver, sodium, potassium, and lithium. Interaction in this context means that the ion beams or the plasma and the molecular beams overlap at least partially during the coating in the coating portion on the substrate.

In this context or alternatively, it can be provided that the punctiform or line shaped ion beam source or plasma source is positioned proximal to the outer limitation of the evaporation chamber or in a center of the evaporator chamber. Thus, for example a substrate pretreatment or a controlled modification of the MoSe transition layer is facilitated, whereas a better overlap with evaporator molecular beams would be provided for a centrally located punctiform and/or line shaped ion beam source which would be restricted for an arrangement proximal to the edge.

Eventually independent patent protection is claimed for the method according to the invention for coating substrates, wherein the method is characterized in that a linear evaporation source is used as the at least one evaporation source and the evaporation chamber according to the invention is advantageously used. It is then advantageously provided that the process environment of the evaporation chamber advantageously includes sulfur, telluride and/or selenium and in particular at least one chalcopyrite layer is generated.

### BRIEF DESCRIPTION OF THE DRAWINGS

The features of the present invention and its advantages are now described in more detail based on embodiments with reference to drawing figures, wherein:

FIG. 1 illustrates a linear evaporator according to the invention in a first advantageous embodiment;

FIG. 2 illustrates a throttle element of the linear evaporator according to the invention according to FIG. 1;

FIG. 3 illustrates an evaporation chamber according to the invention with two linear evaporators according to the invention according to FIG. 1;

FIG. 4 illustrates a preferred embodiment of the evaporation chamber according to the invention;

FIG. 5 illustrates an embodiment of a deposited layer sequence of a CIS thin film solar cell;

FIG. 6a illustrates a linear evaporator according to the invention in a second preferred embodiment;

FIG. 6b illustrates a linear evaporator in a third preferred embodiment; and

FIGS. 7a and 7b illustrate a nozzle plate according to the invention in a preferred embodiment in a top view and a cross-sectional view.

### DETAILED DESCRIPTION OF THE INVENTION

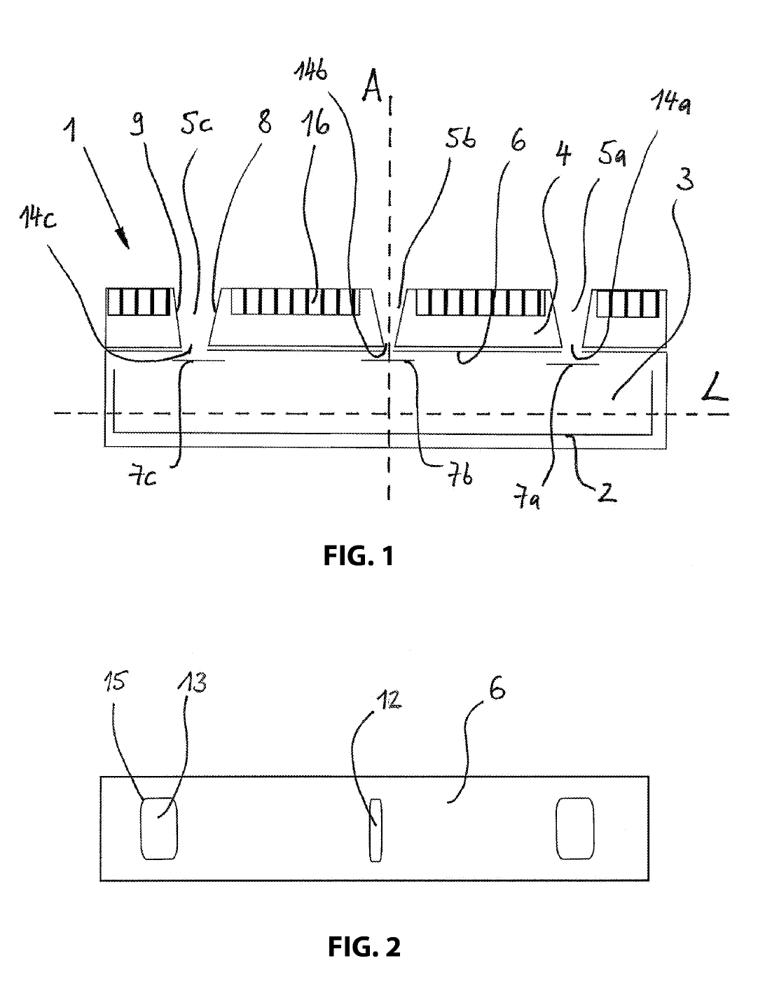

FIG. 1 schematically illustrates the linear evaporation source 1 according to the invention in a first preferred embodiment in a sectional view. The linear evaporation source 1 includes an evaporation material container 2 with a recess 3 for receiving material to be evaporated (not illustrated). Furthermore, a nozzle plate 4 with nozzles with vapor outlet openings 5a, 5b, 5c is provided which are arranged offset from one another in longitudinal direction L of the linear evaporation source 1. Furthermore, a throttle element 6 is provided and aperture elements 7a, 7b, 7c.

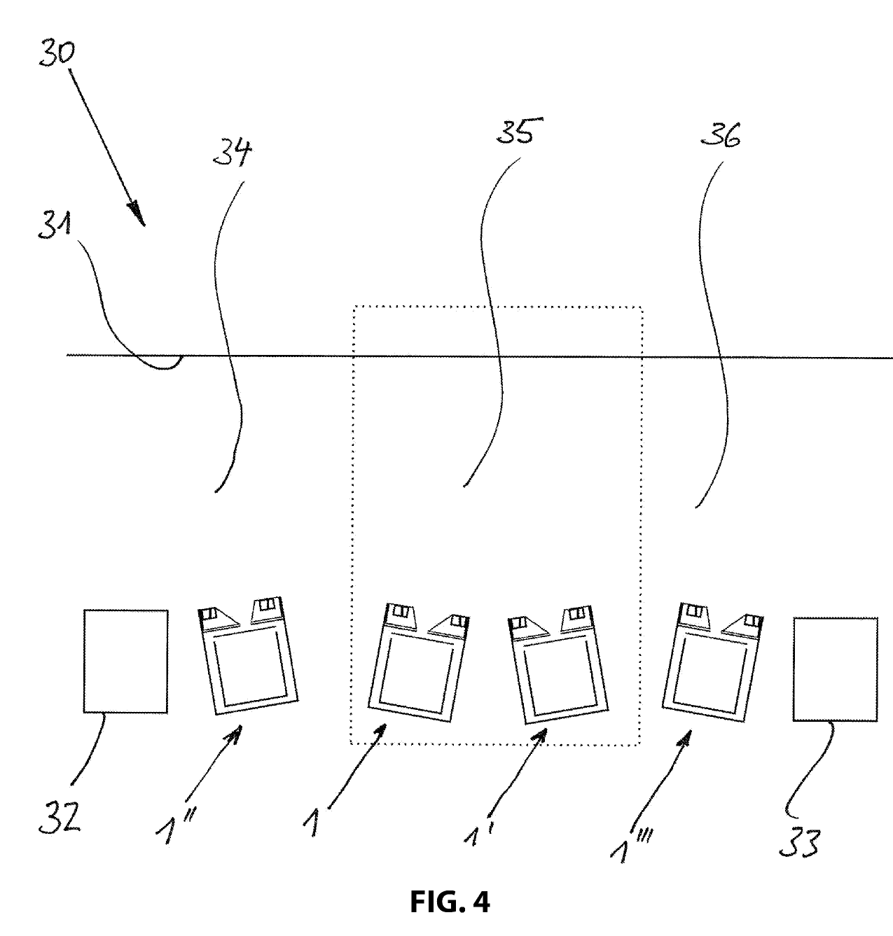

The vapor outlet openings 5a, 5b, 5c respectively include four wall portions 8, 9, 10, 11, wherein two wall portions 8, 9 extend vertical to the longitudinal direction L and two wall portions 10, 11 extend parallel to the longitudinal direction L as illustrated in more detail in FIG. 3. The vapor outlet openings 5a, 5b, 5c additionally include a conically opening configuration, wherein wall portions 10, 11 extending parallel to the longitudinal direction L have different inclinations relative to the nozzle element 4. Also the wall portions 8, 9 extending perpendicular to the longitudinal direction L of the two outer vapor outlet openings 5a, 5c have different inclinations relative to the nozzle element 4. The center vapor outlet opening 5b on the other hand side includes wall portions extending perpendicular to the longitudinal direction L, wherein the wall portions have identical inclinations relative to the nozzle element 4. Thus, the longitudinal axes B of the vapor outlet openings 5a, 5b, 5c extend at a slant angle relative to the container axis A.

In the instant embodiment, one respective vapor outlet opening 5a, 5b, 5c is provided per nozzle so that identical elements are provided. However, it can also be provided that one or plural nozzles include plural vapor outlet openings.

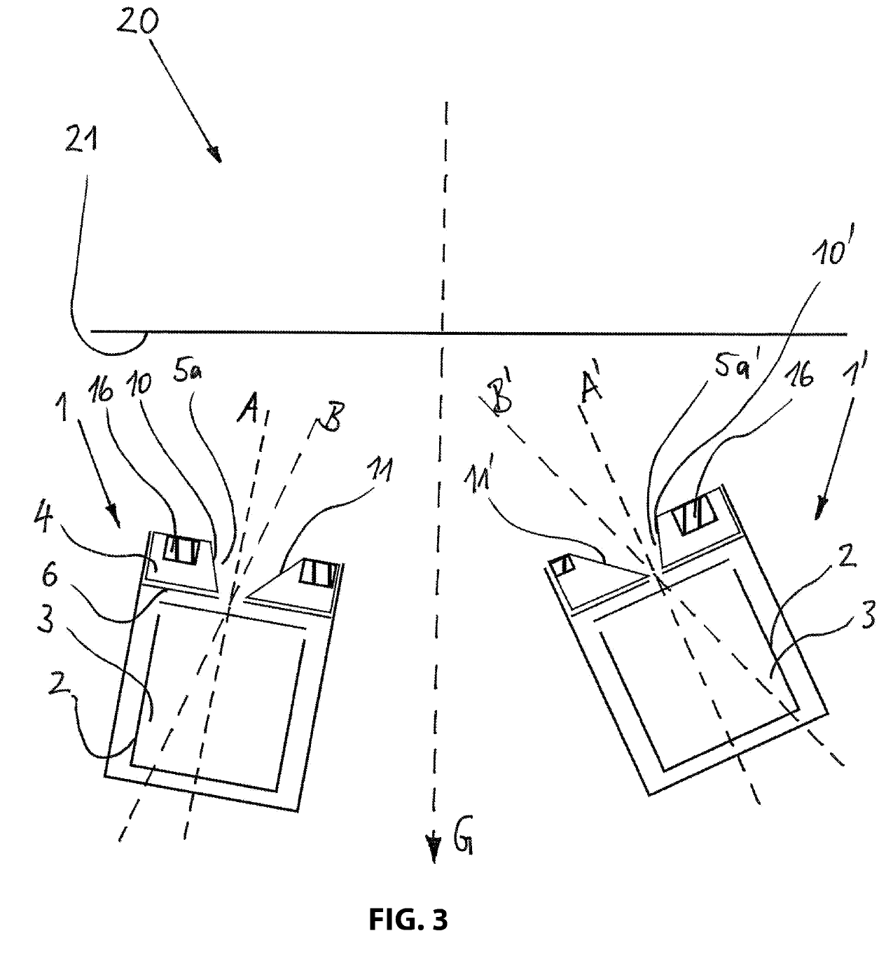

As illustrated in FIG. 2, the throttle element 6 respectively includes throttle openings 12, 13 respectively associated with the vapor outlet openings 5a, 5b, 5c, whose cross-sectional surfaces essentially correspond to the initial openings 14a, 14b, 14c of the vapor outlet openings 5a, 5b, 5c. Presently it is additionally provided that the corner portions 15 of the throttle openings 12, 13 are configured rounded. Thus, the throttle element 6 is not used for regulating a molecular beam density but for protecting the nozzle element 4 against the evaporated material. However, a controlled cross-sectional reduction of individual or all throttle openings 12, 13 can be provided relative to the initial openings 14a, 14b, 14c of the vapor outlet openings 5a, 5b, 5c in order to control the particular molecular beam densities.

The throttle openings 12, 13 are arranged in viewing direction between the recess 3 and the vapor outlet openings 5a, 5b, 5c. Between the throttle openings 12, 13 and the recess 3, aperture elements 7a, 7b, 7c of the respective throttle openings 12, 13 and the respective vapor outlet openings 5a, 5b, 5c are associated with one another. The aperture elements 7a, 7b, 7c thus respectively have an extension so that they completely cover the throttle openings 12, 13 in viewing direction so that an exit of evaporation material as squirts is effectively prevented through the vapor outlet openings 5a, 5b, 5c. The nozzle element 4 is attached at the linear evaporation source 1 through a clip connector so that replacement can be easily performed with another nozzle element 4. Furthermore, the nozzle element 4 can also be arranged at the linear evaporation source 1 in an orientation that is rotated about the container axis A and in an orientation that is rotated about the longitudinal direction L so that one nozzle element facilitates four different beam shapes, even when the nozzle geometries are fixated. Alternatively thereto it can also be provided that one or plural wall portions 8, 9, 10, 11 are tiltable relative to the nozzle element 4 in order to provide particular beam forming.

Furthermore, heat reflectors 16 are machined into the nozzle element 4. These heat reflectors 16 reduce a temperature gradient between the melt surface of the evaporation material and the vapor outlet openings 5a, 5b, 5c. By using these heat reflectors 16, a deposition and thus a clogging of the vapor outlet openings 5a, 5b, 5c with evaporation material and also with its compounds, for example selenium arranged in the evaporation chamber is prevented.

In FIG. 3, the evaporation chamber 20 according to the invention is schematically illustrated in a preferred embodiment in a sectional view. A flexible band substrate 21 is supported in the evaporation chamber 20 through a planar substrate support (not illustrated), for example through transport rollers and band drums and run through a coating portion 22 of the evaporation chamber 20, wherein the outer walls of the evaporation chamber are not illustrated in detail either.

The evaporation chamber 20 includes two linear evaporation sources 1, 1′ according to the invention, wherein like elements are provided with like reference numerals. The linear evaporation sources 1, 1′ respectively include container axes A, A′ oriented differently relative to gravity G, wherein a tilting of the container axes A, A′ relative to gravity G can be adapted through suitable devices. Furthermore, the longitudinal axes B, B′ of the vapor outlet openings 5a, 5a′ of the linear evaporation sources 1, 1′ are tilted differently relative to the respective container axes A, A′. Thus it is facilitated that the vapor beams of the linear evaporation sources 1, 1′ are respectively formed in a particular manner and deposit or mix on the substrate in an optimum manner. For example, indium is evaporated in the first linear evaporation source 1 and selenium is evaporated in the second linear evaporation source 1′ and a third coating device for copper is provided in order to deposit a chalcopyrite layer for a thin film solar cell on the substrate. In this special method, linear evaporation sources 1, 1′ can be spaced particularly tightly, this means up to 0.05 m, and in order to deposit a particularly homogeneous layer, the linear evaporation sources 1, 1′ should be arranged as closely as possible, this means for example arranged 0.1 m from the substrate.

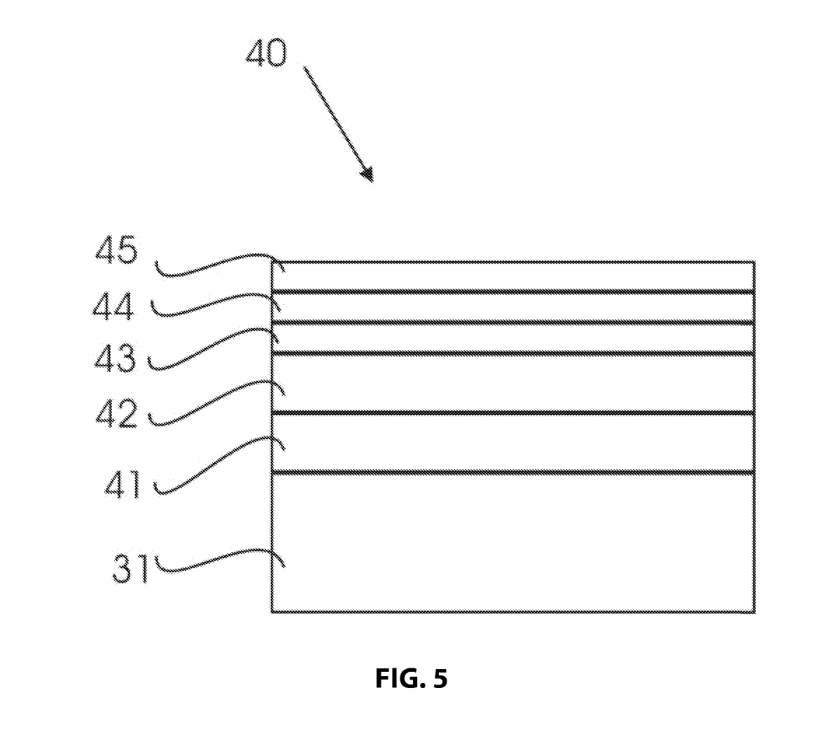

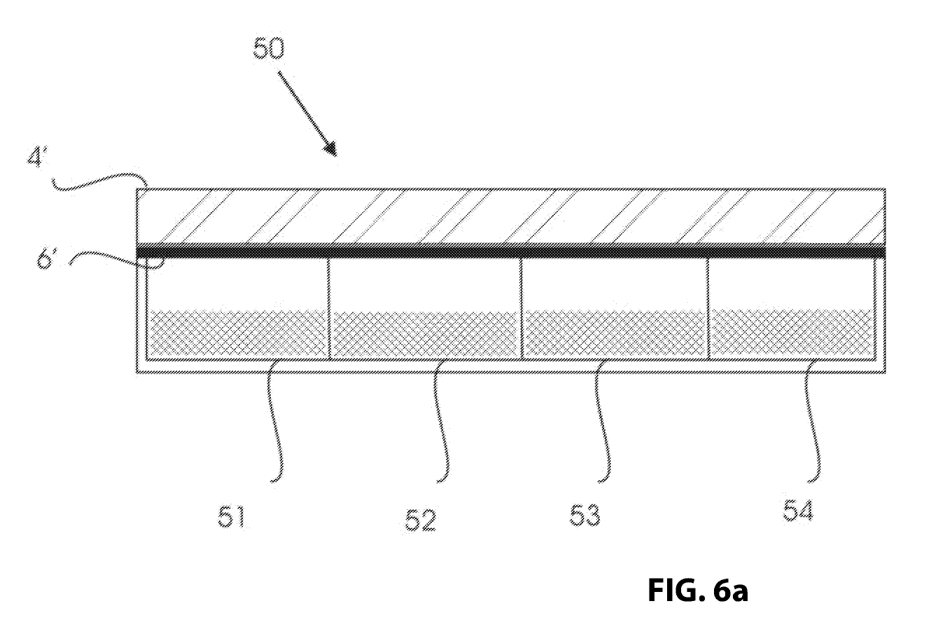

FIG. 4 illustrates a particular preferred embodiment of the evaporation chamber 30 according to the invention in a schematic manner, whose typical components like pumps, gates, valves and similar are well known for a person skilled in the art and are therefore not illustrated in detail. In this case, a CIS layer made from Cu(Ga,In)Se₂ is deposited in a coating arrangement 30 on a glass substrate 31 in an inline process in order to provide a CIS thin film solar cell 40 according to FIG. 5. Thus it has proven particularly advantageous when the substrate 31 already coated with a back contact 41 is initially coated with copper which is evaporated from a linear evaporation source 1″ illustrated in FIG. 1 and an ion beam made from selenium from the first ion beam source 32 in order to form a selenium-copper mix layer 42, wherein the molecular beam of the linear evaporation source 1″ and the ion beam of the ion beam source 32 overlap on the coating surface. Subsequently the substrate 31 thus coated is coated with gallium and indium with a linear evaporation source respectively depicted in FIG. 1 in order to form a gallium-indium mix layer 43. In order to increase the efficiency of the solar cell which is essentially defined by the absorbers, potassium fluoride is coated from one of the linear evaporation sources 1″′ described in FIG. 1 whose molecular beam overlaps with an additional sulfur bearing ion beam of a second ion beam source 33 in order to form a potassium-selenium mix layer 44.

These deposition processes are respectively performed in different portions 34, 35, 36 of the coating arrangement 30 that are separated from one another. In order to perform the ion beam based partial processes, a large distance of up to 3 m of the linear evaporation sources 1, 1′, 1″, 1″′ from the substrate 31 has proven advantageous. As a result therefrom, a large distance of the copper linear evaporator from the gallium-indium linear evaporator of up to 1.0 m shall be adjusted. A mixing of copper, indium and gallium in this portion of the described multi step coating process would negatively influence the efficiency of the solar cell. Since the linear evaporation sources 1, 1′, 1″, 1″′ in this special application have a large distance from the heated up substrate 31, the nozzles have to be provided with heat reflectors 16 made from tantalum since otherwise compounds including selenium are deposited at the vapor outlet openings 5a, 5b, 5c which would otherwise clog up.

In order to form the thin film solar cells 40, additionally a CdS layer 44 is applied as a buffer layer and a front electrode 45 onto the Cu(Ga,In)Se₂ absorber layer formed from the layers 42, 43.

FIG. 4 thus illustrates a preferred embodiment for CIS deposition. When this schematically illustrated process shall be scaled to greater substrate widths, also the linear evaporation sources and the linear ion beam sources have to be scaled accordingly. An evaporation material container of for example 1 m may be manageable still during cleaning and evaporation material filling, for which the evaporation material container has to be removed from the linear evaporation source. For an even longer linear evaporation source with an evaporation material length of for example 3 m, 5 m or later even up to 10 m, this is not possible anymore. Only removing the evaporation material container is very difficult and most likely not doable. The evaporation material container can fracture during unfavorable handling solely through its tare weight. When the evaporation material container 2 is filled with evaporation material, the risk is increased that the evaporation material container can fracture. Furthermore, additional space is required for maintaining and supporting for example supplemental evaporation material containers.

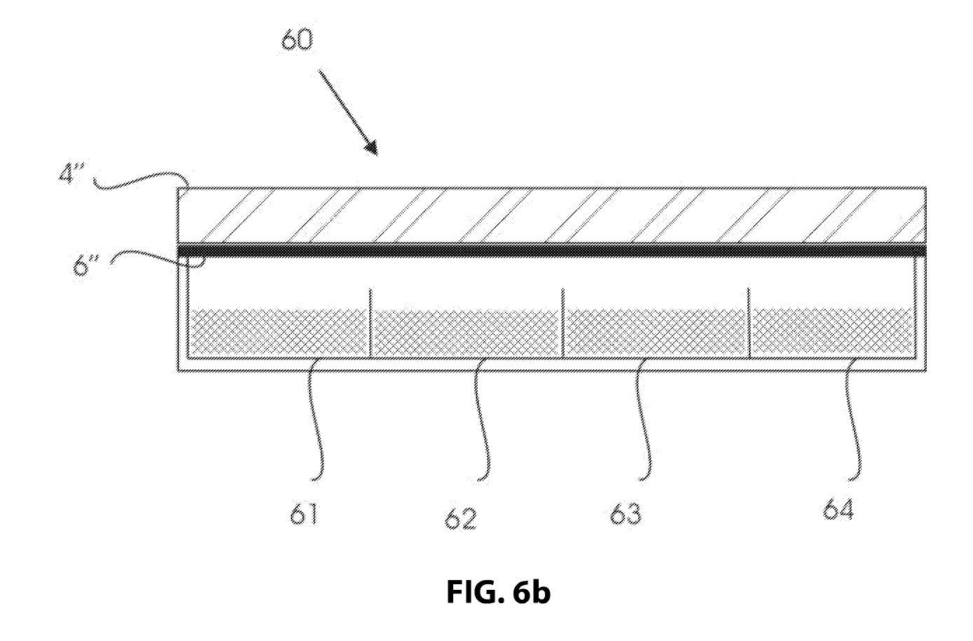

Therefore, the evaporation material container in particular for linear evaporation sources suitable for mass production of CIS should be divided into plural so-called evaporation material container modules. FIGS. 6a and 6b illustrate two preferred embodiments of linear evaporation material sources 50, 60 in which the modules 51, 52, 53, 54, 61, 62, 63, 64 are configured differently.

It is an advantage of the concept illustrated in FIG. 6a, in which a separate vapor equilibrium is established in each module so that the modules are separated from one another, that evaporation material consumption is uniform. However, a complex configuration of the components arranged there above, namely the throttle elements 6′ and the nozzle elements 4′ is a disadvantage.

It is an advantage of the concept of the evaporation material container modules illustrated in FIG. 6b, in which an identical vapor equilibrium pressure is provided over each module 61, 62, 63, 64 that the modules are not separated from one another, that a stable transversal homogeneity of the substrate is provided for a relatively simple configuration of the components arranged there above, namely the throttle elements 6″ and the nozzle elements 4″.

Through the larger cross-sectional surface 14a, 14c illustrated in FIG. 2 of the outer vapor outlet openings 5a, 5c opposite to the inner vapor outlet opening 5b, it is caused that sufficient material is also applied in edge portions of a substrate. The tilting of the nozzle axis B illustrated in FIG. 1 relative to the container axis A with reference to the longitudinal direction L leads to a particularly high homogeneity of the evaporation material along the longitudinal direction L, thus along a transversal direction of a substrate 21 moved along perpendicular to a longitudinal direction L of the linear evaporation source 1.

This configuration according to the invention thus facilitates a particularly high homogeneity and facilitates high mass flow rates. The stability of the mass flow rates can even be increased in that the container axes A, A′ of the linear evaporation sources 1, 1′ are aligned parallel to the gravitation direction G. Thus, evaporation material with a constant surface is respectively arranged in the indentation 3, so that a constant mass flow also up to a complete consumption of the evaporation material is assured. In this case, the linear evaporation sources 1, 1′ have to be positioned more closely relative to one another and/or the nozzle axes B, B′ have to be tilted more strongly relative to the container axes A, A′, so that the vapor stream impacts the substrate surface vertically. However, a non vertical impact can be useful and desirable in particular cases.

Though plural nozzles with a respective vapor outlet opening 5a, 5b, 5c are illustrated in the advantageous embodiment, it can also be provided according to the invention that the linear evaporation sources include a singular nozzle with a singular vapor outlet opening which then extends in longitudinal direction of the linear evaporation source.

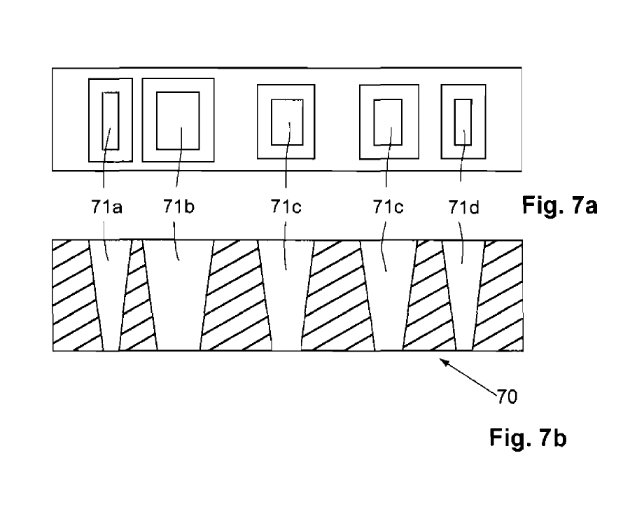

An advantageous embodiment of the nozzle plate 70 according to the invention is schematically illustrated in FIG. 7a and in FIG. 7b in a top view or in a cross-sectional view.

It is apparent that the nozzle plate 70 according to the invention includes different nozzles 71a, 71b, 71c, 71d, namely different with respect to the distance from one another and the respective width in longitudinal direction and also in transversal direction of the nozzle plate. The opening angles of the nozzles 71a, 71b, 71c, 71d are for example the same, however, also here variations can be provided in order to adjust particular desired beam profiles.

Using an evaporation material container with modular configuration, which is assembled from plural small evaporation material containers 51, 52, 53, 54, 61, 62, 63, 64, facilitates simple scaling with reference to the longitudinal extension of the evaporator 50, 60 and in particular for linear evaporators 50, 60 that are very long, a simple handling. Furthermore, a risk of negligent destruction of the evaporation material container during maintenance is significantly reduced. Additionally, individual small non-functional evaporation material containers 51, 52, 53, 54, 61, 62, 63, 64 can be replaced quickly which is more cost effective than replacing a large evaporation material container.

Alternatively or additionally thereto, it can also be provided that the nozzle plate is configured modular from plural nozzle plate segments (not illustrated).

The linear evaporator 1, 1′ according to the invention has 30 to 40% better material yield over punctiform evaporation cells. Homogeneity is significantly improved over known linear evaporation cells and is in particular much better suited for flexible substrate support and growing substrate width and in particular flexibly adaptable to particular requirements.

This adaptability exists in particular based on the particular nozzle shape provided according to the invention or its orientation relative to the container axis A, A′ which can be provided differently through various nozzle elements 4.

Furthermore, adjustability of the nozzle shape can even be provided within a particularly adapted nozzle element, in which for example the wall portions 8, 9, 10, 11 are arranged tiltable.

What is claimed is:

1. A linear evaporation source, in particular for vacuum deposition arrangements, comprising:
at least one evaporation material container including
an indentation for receiving the evaporation material,
at least one heat source, and
at least two nozzles arranged offset in longitudinal direction of the linear evaporation source,
wherein the nozzles respectively include at least one vapor outlet opening,
wherein the evaporation material container includes a container axis,
wherein the at least one vapor outlet opening includes at least two wall sections which preferably extend substantially vertical to the longitudinal direction and which are oriented not parallel or orientable not parallel to one another,
wherein the evaporation material container is separable into at least two evaporation material container modules which are not separated from one another in a joined condition of the evaporation material container so that an identical vapor equilibrium pressure is established in or over each evaporation material container module through evaporating evaporation material in the respective evaporation material container module.

2. The linear evaporation source according to claim 1, wherein the at least one vapor outlet opening is configured conical with respect to the two wall sections, in particular configured asymmetrically conically expanded.

3. The linear evaporation source according to claim 1, wherein the evaporation material container is configured modular with 3 to 40 smaller evaporation material container modules.

4. The linear evaporation source according to claim 1, wherein the at least two nozzles respectively include at least one heat reflector, which is made from at least one piece of sheet metal made from a temperature resistant material from the group of metals from the fourth to ninth subgroup of the period system of elements or their alloys.

5. The linear evaporation source according to claim 4, wherein the at least one heat reflector is arranged adjacent to or about the vapor outlet opening.

6. The linear evaporation source according to claim 1,
wherein a longitudinal extension of the evaporation material container modules is much greater than a transversal extension,
wherein a ratio of the longitudinal extension to the transversal extension of the evaporation material container modules is at least 5 and at the most 30.

7. The linear evaporation source according to claim 1,
wherein the at least one vapor outlet opening has a longitudinal axis which is arranged or arrangeable titled relative to the container axis,
wherein the tilt is advantageously 1° to 90°.

8. The linear evaporation source according to claim 1,
wherein the nozzles are arranged in at least one nozzle element, configured as a nozzle plate which is disengageably connected with the evaporation material container, and
wherein the nozzle plate configured solid and made from graphite.

9. The linear evaporation source according to claim 8, wherein the nozzle element is connectable with the evaporation material container in an orientation that is rotatable about a container axis or about the longitudinal direction, so that various beam shapes are implementable with the nozzle element even when the nozzle geometries in the nozzle element are fixated.

10. The linear evaporation source according to claim 1,
wherein a throttle element is arranged between a nozzle and the indentation,
wherein the throttle element includes at least one throttle opening which is arranged in viewing direction between the nozzle and the indentation,
wherein an overall cross-sectional area of the throttle openings of the respective nozzle for at least one nozzle which is arranged further outside with respect to the longitudinal direction is equal to or greater than for at least one nozzle that is arranged further inside,
wherein it is provided that an aperture element is arranged in viewing direction between the indentation and the throttle opening or between the throttle opening and the nozzle as a splash guard,
wherein the aperture element covers in particular the overall cross-sectional area of the throttle openings in viewing direction.

11. An evaporation chamber, comprising:
at least one evaporation source and
at least one substrate holder or substrate support for flat substrates, band substrates or similar,
wherein the evaporation source is a linear evaporation source according to claim 1,
wherein the container axis of the linear evaporation source is arranged or arrangeable relative to the gravitation orientation inclined by 0° to 40°.

12. The evaporation chamber according to claim 11, wherein a band substrate support is provided as a substrate support which includes a straight or a curved section and the linear evaporation source is arranged so that it vapor deposits the substrate material in the straight or the curved section.

13. The evaporation chamber according to claim 11,
wherein at least two linear evaporation sources are provided,
wherein at least the two linear evaporation sources are arranged or arrangeable slanted relative to one another with their container axes or their container axes are oriented identical.

14. The evaporation chamber according to claim 11,
wherein at least two linear evaporation sources are provided whose respective longitudinal axes of the respective vapor outlet opening are arranged identical or differently relative to the respective container axis or
wherein the linear evaporation source has a distance of 0.05 m to 2.00 m to the substrate or
wherein the linear evaporation sources have a distance from one another of 0.01 m to 3.00 m or
wherein at least one punctiform or line shaped ion beam source or plasma source is arranged in the evaporation chamber,
wherein the line shaped ion beam source or the plasma source is preferably heated and positioned in particular proximal to an outer boundary of the evaporation chamber or in a center of the evaporation chamber.

15. A method for coating substrates,
wherein at least one linear evaporation source according to claim 1 is used in an evaporation chamber including
at least one evaporation source and
at least one substrate holder or substrate support for flat substrates, band substrates or similar,
wherein the container axis of the linear evaporation source is arranged or arrangeable relative to the gravitation orientation inclined by 0° to 40°, and
wherein a process environment includes sulfur, telluride, or selenium, and at least one chalcopyrite layer is generated.

16. The linear evaporation source according to claim 1, wherein the at least two nozzles respectively include at least one heat reflector, which is made from at least one piece of sheet metal made from a temperature resistant material from the group of metals from the fourth to ninth subgroup of the period system of elements and their alloys.

17. The linear evaporation source according to claim 1,
wherein a throttle element is arranged between a nozzle and the indentation,
wherein the throttle element includes at least one throttle opening which is arranged in viewing direction between the nozzle and the indentation,
wherein an overall cross-sectional area of the throttle openings of the respective nozzle for at least one nozzle which is arranged further outside with respect to the longitudinal extension is equal to or greater than for at least one nozzle that is arranged further inside,
wherein it is provided that an aperture element is arranged in viewing direction between the indentation and the throttle opening and between the throttle opening and the nozzle as a splash guard,
wherein the aperture element covers in particular the overall cross-sectional area of the throttle openings in viewing direction.

18. The evaporation chamber according to claim 11, wherein a band substrate support is provided as a substrate support which includes a straight and a curved section and the linear evaporation source is arranged so that it vapor deposits the substrate material in the straight and the curved section.

19. The evaporation chamber according to claim 11,
wherein at least two linear evaporation sources are provided whose respective longitudinal axes of the respective pass through opening are arranged identical or differently relative to the respective container axis, and
wherein the linear evaporation source has a distance of 0.05 m to 2.00 m to the substrate, and wherein the linear evaporation sources have a distance from one another of 0.01 m to 3.00 m, and
wherein at least one punctiform and line shaped ion beam source or plasma source is arranged in the evaporation chamber,
wherein the line shaped ion beam source or the plasma source is preferably heated and positioned in particular proximal to an outer boundary of the evaporation chamber or in a center of the evaporation chamber.

20. A method for coating substrates,
wherein at least one linear evaporation source according to claim 1 is used in an evaporation chamber including
at least one evaporation source and
at least one substrate holder or substrate support for flat substrates, band substrates or similar,
wherein the container axis of the linear evaporation source is arranged or arrangeable relative to the gravitation orientation inclined by 0° to 40°, and
wherein a process environment includes sulfur, telluride and selenium, and at least one chalcopyrite layer is generated.
